(19) United States
(12) Patent Application Publication
(10) Pub. No.: US 2026/0300496 A1
(43) Pub. Date: Oct. 1, 2026

(54) SYSTEMS AND METHODS FOR DETECTING AND REMEDIATING SECURITY VULNERABILITIES IN SOURCE CODE USING MACHINE LEARNING

(71) Applicant: Capital One Services, LLC, McLean, VA (US)

(72) Inventor: Urooj SIRAJ, McLean, VA (US)

(73) Assignee: Capital One Services, LLC, McLean, VA (US)

(21) Appl. No.: 19/092,393

(22) Filed: Mar. 27, 2025

(51) Int. Cl. G06F 21/57; G06F 8/10

(52) U.S. Cl. CPC G06F 21/577; G06F 8/10; G06F 2221/033

(57) ABSTRACT

A method may include receiving, using a large language model (LLM), first code and information associated with the first code, the information representing an impact analysis, system documentation, and a plurality of requirements. The method may include tokenizing, using the LLM, the first code and the information. The method may include determining, using the LLM, a plurality of characteristics associated with the first code based on the tokenized first code and the tokenized information. The method may include determining, using the LLM, a plurality of security vulnerabilities associated with the first code based on the plurality of characteristics. The method may include ranking, using the LLM, each of the plurality of security vulnerabilities associated with the first code based at least in part on the impact analysis. The method may include determining, using the LLM, at least second code to remediate one or more of the plurality of security vulnerabilities.

### TECHNICAL FIELD

Various embodiments of this disclosure relate generally to techniques for detecting and remediating security vulnerabilities in source code using machine learning and, more particularly, to systems and methods for detecting and remediating security vulnerabilities in source code using one or more generative machine learning models such as large language models (“LLMs”).

### BACKGROUND

Organizations that develop applications (e.g., programs or software) often desire to eliminate or minimize flaws or weaknesses in the applications that could be exploited by cybercriminals (e.g., using malware), social engineers, or other actors. As a result, such organizations often have their employees or others manually review the applications'source code for security threats. For instance, a company that develops an application may have one of the company's employees manually gather and analyze the application's source code and any related information, to identify any flaws or weaknesses (e.g., threats or potential threats) in the source code. However, it may take the employee considerable time and effort to do this. That is, the employee may need to collect the source code and any related information from one or more teams, or from computing systems or networks that may be intricate. The employee may need to review the source code and any related information to understand the source code's functionality, and to identify any threats or potential threats to the source code. The employee may also need to prepare detailed documents or reports regarding the employee's analysis. Moreover, in some cases, the employee may need to identify or develop countermeasures to address any identified threats or potential threats to the source code. Such actions may not only be time-consuming and labor-intensive for the employee, but also cause the company to incur significant costs (e.g., payroll costs associated with the employee).

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for for detecting and remediating security vulnerabilities in source code using machine learning, are disclosed. Each of the examples disclosed herein may include one or more features described in connection with any of the other disclosed examples.

In one aspect, an exemplary embodiment of a method may include receiving, using a large language model (LLM) of a first computing system, first code and information associated with the first code, the information representing an impact analysis, system documentation, and a plurality of requirements. The method may include tokenizing, using the LLM, the first code and the information associated with the first code. The method may include determining, using the LLM, a plurality of characteristics associated with the first code based on the tokenized first code and the tokenized information associated with the first code. The method may include determining, using the LLM, a plurality of security vulnerabilities associated with the first code based on the plurality of characteristics. The method may include ranking, using the LLM, each of the plurality of security vulnerabilities associated with the first code based at least in part on the impact analysis. The method may also include determining, using the LLM, at least second code to remediate one or more of the plurality of security vulnerabilities.

In another aspect, an exemplary embodiment of a computer system may include a processor and a memory having programming instructions stored thereon, which, when executed by the processor, cause the computing system to perform operations. The operations may include receiving, using a generative machine learning model of a first computing system, first code and information associated with the first code, the information representing an impact analysis, system documentation, and a plurality of requirements. The operations may include tokenizing, using the generative machine learning model, the first code and the information associated with the first code. The operations may include determining, using the generative machine learning model, a plurality of characteristics associated with the first code based on the tokenized first code and the tokenized information associated with the first code. The operations may include determining, using the generative machine learning model, a plurality of security vulnerabilities associated with the first code based on the plurality of characteristics. The operations may include ranking, using the generative machine learning model, each of the plurality of security vulnerabilities associated with the first code based at least in part on the impact analysis. The operations may also include determining, using the generative machine learning model, at least second code to remediate one or more of the plurality of security vulnerabilities.

In a further aspect, an exemplary embodiment of a method may include receiving, using a large language model (LLM), first code and information associated with the first code, the information representing an impact analysis, system documentation, and a plurality of requirements. The method may include tokenizing, using the LLM, the first code and the information associated with the first code. The method may include determining, using the LLM, a plurality of characteristics associated with the first code based on the tokenized first code and the tokenized information associated with the first code. The method may include determining, using the LLM, a plurality of security vulnerabilities associated with the first code based on the plurality of characteristics. The method may include ranking, using the LLM, each of the plurality of security vulnerabilities associated with the first code based on the impact analysis and a likelihood of a respective one of the plurality of security vulnerabilities being exploited. The method may also include determining, using the LLM, at least second code to remediate one or more of the plurality of security vulnerabilities.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 illustrates an example operation for detecting and remediating threats, according to one or more embodiments.

FIG. 3 illustrates an example framework for detecting and remediating threats, according to one or more embodiments.

FIG. 4 illustrates an example method, according to one or more embodiments.

FIG. 5 illustrates a flow diagram for training a machine learning model, according to one or more embodiments.

FIG. 6 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In the following description, embodiments will be described with reference to the accompanying drawings. As will be discussed in more detail below, various embodiments, systems, and methods for detecting and remediating security vulnerabilities in source code using machine learning, are described.

In an exemplary use case, a company may wish to detect and remediate any weaknesses, flaws, or risks (collectively, “threats” or “security vulnerabilities”) in a newly developed application, where such threats relate to the security of the application. To perform the detection and remediation, (i) source code of the application, (ii) business requirements associated with the application, (iii) system documents associated with the application, and (iv) an impact analysis (e.g., an analysis of consequences to the company that may result if threats are realized) associated with the application, may be input to an LLM of a computing system. The LLM may tokenize the inputs, and determine characteristics of the source code based on at least a portion of the tokenized inputs. The LLM may further determine threats associated with the source code based on the characteristics and the tokenized inputs. The LLM may rank the threats and output a threat model (or report) that includes the ranked threats. In some embodiments, the LLM may further determine suggested remediations for the threats, where the suggested remediations may be included in the threat model. Further, in some embodiments, the LLM may generate software patches to remediate one or more of the threats included in the threat model.

Conventionally, manual processes are used to detect and remediate threats associated with source code. However, such processes are often time-consuming, involve subjective judgments, and are difficult to scale. Yet aspects of the present disclose provide systems and methods for detecting and remediating such threats in a more efficient, objective, and scalable manner. Moreover, because embodiments described herein involve using multiple inputs (e.g., code, impact analyses, system documents, requirements documents, among others), the embodiments facilitate a more holistic and contextualized approach to detecting threats in source code relative to existing techniques. Such embodiments also support detecting threats more accurately (or with fewer false positives) relative to conventional processes.

While the example above involves an LLM, it should be understood that the systems and methods of this disclosure may be adapted to any suitable type of machine learning model. Further, it should be understood that the example above is illustrative only. The techniques and technologies of this disclosure may be adapted to any suitable activity.

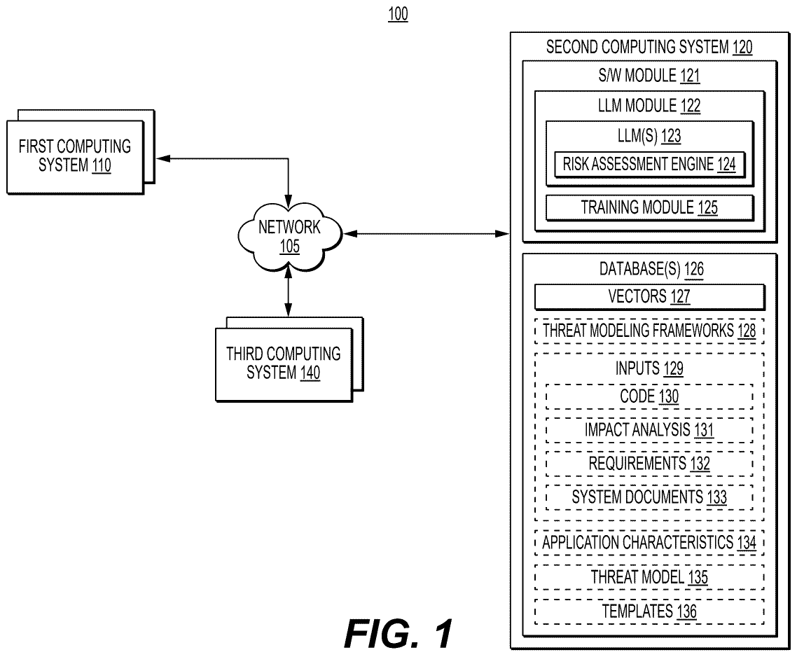

FIG. 1 depicts an example environment 100 that may be utilized with techniques presented herein. As shown in FIG. 1, the example environment 100 may include one or more of a first computing system 110, a second computing system 120, a third computing system 140, and an electronic network 105. In some aspects, the first computing system 110, the second computing system 120, and the third computing system 140 may communicate with one another in any arrangement, across the electronic network 105. In some embodiments, the environment 100 may be associated with (e.g., owned, rented, controlled, or used by) an entity such as an organization, company, non-profit, or the like.

The first computing system 110 may include one or more computer systems such as desktop computers, workstations, servers, laptops, mobile devices, tablets, or the like. In some examples, the first computing system 110 may be associated with (or include) a cloud computing platform with scalable resources for computation or data storage. The first computing system 110 may run one or more applications locally or using the cloud computing platform.

In some aspects, the first computing system 110 may facilitate one or more continuous integration and continuous deployment (“CI/CD”) pipelines. In some aspects, a CI/CD pipeline may represent a set of practices or tools used by software developers to integrate code changes into a codebase (e.g., of version control system or repository) and to automate the building, testing, and deployment of applications. In some aspects, a software developer may use the first computing system 110 to perform a code commit, which refers to saving a change to the codebase. Put differently, a code commit may represent code (e.g., source code) or a software patch that is integrated with the codebase and saved. In some embodiments, a code commit may represent a trigger that may cause the first computing system 110 to transmit one or more of the code commit, the codebase, a portion of the codebase, or associated information (as further discussed herein) to the second computing system 120, via the network 105.

The second computing system 120 may include one or more computer systems such as desktop computers, workstations, servers, laptops, mobile devices, tablets, or the like. In some examples, the second computing system 120 may be associated with (or include) a cloud computing platform with scalable resources for computation or data storage. The second computing system 120 may run one or more applications locally or using the cloud computing platform, to perform various computer-implemented methods described in this disclosure.

As shown in FIG. 1, the second computing system 120 may include a software (“S/W”) module 121 and database(s) 126. The software module 121 may include a large language model (“LLM”) module 122. In some aspects, the LLM module 122 may be configured to train, validate, and deploy one or more LLM(S) 123 or one or more LLM agents, machine learning models, generative machine learning models, or other artificial intelligence models. In some embodiments, the LLM(S) 123 may represent one or more of a GPT-3 model, a BERT model, a ReOBERTa model, or a natural language processing model. In addition or in the alternative, the LLM(S) 123 may represent one or more of a Codex model, a CodeBERT model, a GraphCodeBERT model, or other code-focused model (e.g., from a cloud provider). In some aspects, the LLM(S) 123 may be configured to interpret and analyze one or more programming languages. Further, the LLM(S) 123 may be configured to receive code 130 and associated information from the first computing system 110. More specifically, the LLM(S) 123 may be configured to receive the code 130 and one or more of (i) an impact analysis 131 associated with the code 130, (ii) requirements 132 associated with the code 130, or (iii) system documents 133 associated with the code 130, from the first computing system 110. In some embodiments, the code 130 may represent code of code commit(s). Further, the code 130 may represent code of a programming language that the LLM(S) 123 are configured interpret and analyze. The impact analysis 131 may represent consequences to the entity (e.g., a business) associated with the environment 100, if the code 130 fails in part or whole due to a malicious attack, beach, comprise, or security lapse. For example, the impact analysis 131 may include information or records that quantitatively or qualitatively describe (i) confidentiality agreements, policies, regulations, or laws that may be breached or violated, (ii) data or technology that may be damaged or compromised, (iii) financial penalties that may result, or (iv) reputational harm that may be suffered, in the event the code 130 experiences a security failure. The requirements 132 may represent business requirements of the entity associated with the environment 100. In some aspects, the business requirements may be associated with (e.g., satisfied in part or in whole by) the code 130. The system documents 133 may represent documents, specifications, or information that include text, images or other media associated with the code 130. For example, the system documents 133 may describe the design, features, or functions of the code 130, or system(s) or architecture(s) (e.g., including architectural component(s)) associated with the code 130. In some embodiments, the LLM(S) 123 may include a pre-processing engine that normalizes all inputs to the LLM(S) 123 into a unified, structure representation.

In some aspects, the LLM(S) 123 may be configured to identify and analyze any weaknesses, flaws (e.g., design flaws), or risks (collectively, “threats,” “potential threats,” or “security vulnerabilities”) associated with the security of the code 130, based on the code 130 and one or more of the impact analysis 131, the requirements 132, the system documents 133, and optionally an intelligence feed (not shown in FIG. 1) that the LLM(S) 123 may receive in real time and that reflects active or known threats that may be relevant to the code 130. Put differently, the LLM(S) 123 may be configured to identify and analyze any threats that are relevant to the code 130, map (e.g., identify or analyze) any attack vectors associated with the code 130, and generate scenarios that are customized or tailored to the entity associated with the environment 100, and that represent threats to the code 130. Such scenarios may include situational or contextual information of the entity associated with the environment 100, and may represent hypothetical or what-if scenarios that the LLM(S) 123 use to test the resiliency of the code 130. In some aspects, an attack vector may represent a pathway or method for obtaining unauthorized access to source code (or a computing system or network). In some embodiments, in order to identify and analyze any weaknesses, flaws, or risks associated with the security of the code 130, map attack vectors, or generate scenarios, the LLM(S) 123 may use one or more threat modeling frameworks 128 such as (i) Spoofing, Tampering, Repudiation, Information Disclosure, Denial of Service, and Elevation of Privilege (the STRIDE methodology), or (ii) Process for Attack Simulation and Threat Analysis (the PASTA methodology). In some aspects, the LLM(S) 123 may select one or more threat modeling frameworks 128 to identify and analyze any security threats to the code 130. Alternatively, the LLM(S) 123 may receive an input from a software developer, where the input represents a selection of one or more of the threat modeling frameworks 128 for the LLM(S) 123 to use to identify and analyze any security threats of the code 130.

As shown in FIG. 1, in some embodiments, the LLM(S) 123 may include a risk assessment engine 124. In some embodiments, risk assessment engine 124 may be configured to assess or evaluate threat(s) identified by the LLM(S) 123. For example, the risk assessment engine 124 may be configured to determine a respective risk score for each of one or more threats identified by the LLM(S) 123 based at least in part on analyzing historical attack trends, system vulnerabilities, or real-time threat intelligence feed(s) received by the LLM(S) 123 (or used to train the LLM(S) 123). As another example, the risk assessment engine 124 may be configured to evaluate one or more threats identified by the LLM(S) 123 based on, for example, determining the likelihood that each of the one or more threats may be realized or exploited by malware, social engineers, or other bad actors, and optionally the consequences or potential consequences of the realization or exploitation. In some embodiments, the risk assessment engine 124 may use the impact analysis 131 to determine such consequences or potential consequences (e.g., breach of confidentiality agreements, policies, regulations, or laws, compromise of data or technology, financial penalties, or reputational harm). Further, in some embodiments, the risk assessment engine 124 may be configured to rank each of the identified one or more threats based on, for example, one or more of the likelihood of each of the one or more threats being realized, and the consequences that may result from (or severity of impact of) the one or more threats being realized. In some aspects, the risk assessment engine 124 may be customized and trained on (i) risk models such as the Damage, Reproducibility, Exploitability, Affected Users, and Discoverability (“DREAD”) model, STRIDE, or the Factor Analysis of Information Risk (“FAIR”) model, or (ii) business requirements documents, impact analyses, or probabilities of threats being realized, in order to assign appropriate weights to the risk assessment engine 124.

In some embodiments, the LLM(S) 123 may be configured to map one or more attack vectors associated with the code 130 (e.g., optionally using the one or more threat modeling frameworks 128), to generate a threat model 135. In some aspects, the threat model 135 may represent one or more of a list, text, summary, image, report, or other media that represent threat(s) or potential threat(s) to the code 130, optionally among other information. In some embodiments, the threat model 135 may include visual aids such as data flow diagrams or attack paths. Further, in some embodiments, the threat model 135 may present information (or use terminology) that is understandable or accessible to a particular audience (e.g., a business team, cybersecurity team, or another team). In some embodiments, the LLM(S) 123 may use a template 136 (e.g., a pre-filled template) to generate the threat model 135, where the template 136 may specify the content or formatting of the threat model 135. In some embodiments, the template 136 may be generated or designed using one or more of the threat modeling frameworks 128. Further, in some aspects, the threat model 135 made by generated or updated in response to (or responsive to) the LLM(S) 123 receiving one or more code commits from the first computing system 110.

Further, in some embodiments, the LLM(S) 123 may be configured to generate one or more suggested or actual remediations for the threat(s) identified in the threat model 135. In some embodiments, the threat model 135 may include the suggested remediations or reference the actual remediations. The suggested remediations may include, for example, recommended strategies, techniques, actions, or code to mitigate or eliminate threat(s) identified in the threat model 135. The actual remediations may represent code such as software patches that strengthen weaknesses detected in the code 130, or that the remediate flaws detected in the code 130. Further, in some embodiments, the LLM(S) 123 may be configured to prioritize the one or more suggested or actual remediations based on, for example, one or more of risk score(s) or impacts (or potential impacts) determined by the risk assessment engine 124.

In some aspects, the LLM(S) 123 may be pre-trained (e.g., to identify threats associated with source code) based on one or more of the threat modeling frameworks 128, for example. In some embodiments, the LLM(S) 123 may be further trained or fine-tuned (e.g., continuously or periodically) using a training module 125 in order to improve the accuracy of the LLM(S) 123. During the fine-tuning, the LLM(S) may identify application characteristics 134 (e.g., features, functionalities, or attributes) of the code 130, as discussed further herein. In some embodiments, the training module 125 may be configured to receive input from one or more software developers to fine-tune the LLM(S) 123. In some other embodiments, the training module 125 may be configured to automatically fine-tune the LLM(S) 123. In some aspects, the training module 125 may train or fine-tune the LLM(S) 123 using historical, current, or synthesized data that represent (i) information representing security coding practices, (ii) code that may be similar or relevant to the code 130, (iii) threats to code that may be similar or relevant to the code 130, (iv) threat models, (v) strategies or code used to remediate threats, (vi) threat reports, or (vii) security blogs. In some embodiments, the training module 125 may use Common Vulnerabilities and Exposures (“CVEs”), information associated with MITRE Adversarial Tactics, Techniques, and Common Knowledge (“MITRE ATT&CK”), or information associated with the Open Web Application Security Project (“OWASP”), to train the LLM(S) 123. In some embodiments, the LLM(S0 123 may be trained (or deployed) using, for example, distributed inference pipelines and Amazon's SageMaker. Further, during development or training of the LLM(S) 123, parallel processing may be used to analyze code files, and incremental analysis may be employed to avoid re-processing unchanged code.

The database(s) 126 may represent one or more storage components (e.g., memories, cache, or the like). As shown in FIG. 1, the database(s) 126 may store vectors 127, which may represent information such as historical threats, historical attack vectors, or common strategies or code to remediate threats. In some embodiments, the vectors 127 may represent information used by the training module 125 to train the LLM(S) 123, as discussed above. Further, in some embodiments, the database(s) 126 may optionally store one or more of the threat modeling frameworks 128, inputs 129 (e.g., the code 130, the impact analysis 131, the requirements 132, and the system documents 133), the application characteristics 134, the threat model 135, and the templates 136. Further, in some embodiments, the database(s) 126 may optionally store a real-time intelligence feed that reflects active or known threats that may be relevant to the code 130, and that is dynamically received by the second computing system 120 via the network 105 or another network.

The third computing system 140 may include one or more computer systems such as desktop computers, workstations, servers, laptops, mobile devices, tablets, or the like. In some examples, the third computing system 140 may be associated with (or include) a cloud computing platform with scalable resources for computation or data storage. The third computing system 140 may run one or more applications locally or using the cloud computing platform, to perform various computer-implemented methods described in this disclosure. In some embodiments, the third computing system 140 may be configured to facilitate the deployment of code or applications that have been analyzed by the LLM(S) 123. Further, the third computing system 140 may be configured to facilitate the deployment of code that has been modified or updated (e.g., to remediate any actual or potential threats to the code) by the first computing system 110 or the second computing system 120.

Although depicted as separate components in FIG. 1, it should be understood that a component or portion of a component in the environment 100 may, in some embodiments, be integrated with or incorporated into one or more other components. For example, one or more of the first computing system 110, the second computing system 120, or the third computing system 140 may be combined. In some embodiments, operations or aspects of one or more of the components discussed above may be distributed amongst one or more other components. Any suitable arrangement or integration of the various systems and devices of the environment 100 may be used.

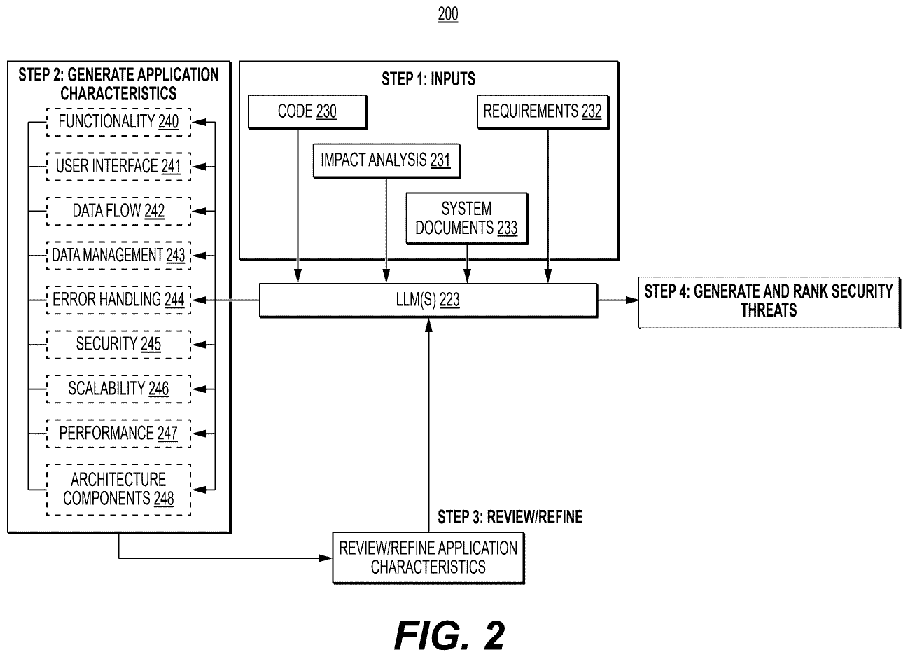

FIG. 2 illustrates an example operation 200 for detecting and remediating threats, according to one or more embodiments. As shown in FIG. 2, the operation 200 may include steps 1-4. At step 1, code 230, an impact analysis 231, requirements 232, and system documents 233 may be input to LLM(S) 223. The code 230, the impact analysis 231, the requirements 232, the system documents 233, and the LLM(S) 223 may be embodiments of the code 130, the impact analysis 131, the requirements 132, the system documents 133, and the LLM(S) 123, respectively, of FIG. 1. While not shown in FIG. 2, in some embodiments, an intelligence feed (e.g., that reflects actual or known threats that may be relevant to the code 230) may also be dynamically inputted to the LLM(S) 223 at step 1.

At step 2, the LLM(S) 223 may parse, interpret, and analyze the code 230, the requirements 232, the system documents 233, and optionally the impact analysis 231. More specifically, the LLM(S) 223 may identify or detect one or more of attributes of the code 230 such as key patterns (e.g., recurring elements or prevalent design patterns), library implementations, function names, function calls, application programming interface (“API”) calls, variables or types of variables, or class hierarchies, which the LLM(S) 223 may use to infer (or determine) and generate one or more application characteristics (e.g., functionalities, features, or operations associated with the code 230). In some embodiments, the identified one or more attributes of the code 230 may be specific to a cloud service, and include, for example, one or more cloud components associated with the code 230. As shown in FIG. 2, the LLM(S) 223 may use the identified one or more attributes to infer, determine, or generate one or more application characteristics such as functionality 240, user interface 241, data flow 242, data management 243, error handling 244, security 245, scalability 246, performance 247, or architecture components 248, each of which may describe or define aspects of the code 230. In some aspects, to generate the one or more application characteristics (or one or more attributes), the LLM(S) 223 may not only analyze the syntax of the code 230, but also evaluate the context and interrelations among components of the code 230. Further, in some embodiments, the LLM(S) 223 may organize the one or more application characteristics into distinct modules or sections. In some embodiments, the LLM(S) 223 may further generate a human-readable summary of the one or more application characteristics. The human-readable summary may include text or images that describe the main functions of the code 230, how a user may interact with the code 230, and data handling processes, for example.

In some embodiments, at step 3, a software engineer may review a human-readable summary generated at step 2, and provide feedback to the LLM(S) 223 to refine (e.g., improve the accuracy of) the one or more application characteristics. Further, the LLM(S) 223 may incorporate such feedback. In some other embodiments, the training module 125 may review the one or more application characteristics generated at step 2 and provide feedback to the LLM(S) 223 to refine the one or more application characteristics, and the LLM(S) 223 may incorporate the feedback. In yet some other embodiments, the LLM(S) 223 may be configured to review and refine (e.g., autonomously) the one or more application characteristics. In some aspects, step 3 may represent a fine-tuning of the LLM(S) 223. In some embodiments, steps 2 and 3 may repeat iteratively until the generated one or more application characteristics represent a desired degree of accuracy or precision. It is noted that the accuracy of the one or more application characteristics may be based on the quality of data or information (including contextual information) used to train the LLM(S) 223, or contextual information (e.g., provided in the code 230, the impact analysis 231, the requirements 232, or the system documents 233) that is input to the LLM(S) 223. Further, the precision of the one or more application characteristics may be based on the quality, clarity, and standard of the code 230.

At step 4, the LLM(S) 223 may use the code 230, the impact analysis 231, the requirements 232, the system documents 233 and optionally other inputs (e.g., an intelligence feed, or one or more of the threat modeling frameworks 128) to infer and generate one or more threats associated with the code 230. In some aspects, the one or more threats may be included in a threat model 135. Further, in some embodiments, the LLM(S) 223 may rank or prioritize each of the threats included in the threat model 135. In some embodiments, the LLM(S) 223 may further generate one or more recommended remediations for the one or more threats, where such recommended remediations may be included in the threat model 135. In addition or in the alternative, the LLM(S) may generate one or more software patches or code to remediate the one or more threats. In some embodiments, the LLM(S) 223 may transmit the threat model 135 and any generated software patches to the first computing system 110 for automatic or manual incorporation in a codebase.

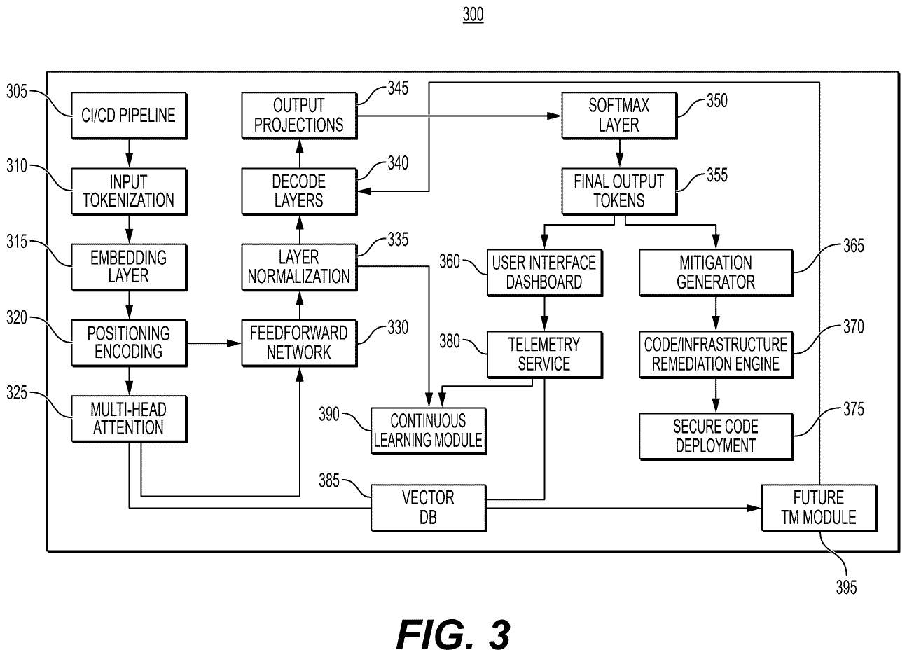

FIG. 3 illustrates an example framework 300 for detecting and remediating threats, according to one or more embodiments. In some embodiments, the framework 300 may be implemented using the environment 100 of FIG. 1. As shown in FIG. 3, the framework 300 may include components or operations 305-395.

At 305, a software developer may perform a code commit within a CI/CD pipeline of the first computing system 110. In some aspects, the code commit may represent a trigger that may cause the first computing system 110 to transmit code of the code commit (e.g., the code 130), optionally along with associated information (e.g., one or more of the impact analysis 131, the requirements 132, and the system documents 133), to the LLM(S) 123 to evaluate the code for one or more threats.

At 310 the LLM(S) 123 may use a tokenizer to tokenize (or parse) the received code and any associated information into tokens for consistent processing. In some aspects, the tokenizer may be pre-trained or pre-configured, and be capable of interpreting multiple programming languages. Further, the tokenizer may output the tokens to an embedding layer of the LLM(S) 123 (at 315).

At 315, the embedding layer of the LLMS (123) may convert the tokens into vectors (e.g., machine-readable vectors, vector representations, dense vector representations, or embeddings) using a code embedding layer (or module), a text embedding layer (or module), and a unified embedding layer (or module). In some aspects, the code embedding layer may represent, for example, a CodeBERT model or a GraphCodeBERT model configured to convert the tokens that represent code into vector representations. The text embedding layer may represent, for example, a BERT model or ReOBERTa model configured to convert the tokens that represent natural language text into vector representations. The unified embedding layer may be configured to combine or integrate the vector representations output from the code embedding layer and the text embedding layer into a single vector space. In some aspects, at 315, the embedding layer may transform the tokens into uniform data representations that facilitate a detailed analysis.

At 320, the LLM(S) 123 may use positional encoding to encode the position of the tokens output from the tokenizer (or vector representations of the embedding layer). In some aspects, the tokens may be associated with a sequence, and the positional encoding may maintain the order (or relative positions) of the tokens within the sequence. Doing so may maintain the logical structure of, and any dependencies associated with, the tokens (or the code and associated information input to the LLM(S) 123). In some embodiments, the tokens and the encoded positions may be output to one or more of a multi-head attention (at 325) or a feedforward neural network (at 330).

At 325, the multi-head attention may receive, as input, one or more of the vector representations output from the embedding layer, the encoded positions, or the tokens. In some aspects, the multi-head attention may have a transformer architecture and include multiple encode layers for contextual understanding of the received inputs. Further, the multi-head attention may process the received inputs (or portions of the received inputs) simultaneously. In some aspects, the multi-head attention may include a self-attention mechanism to capture (or infer or identify) relationships across the received inputs. Further, the multi-head attention may include a head configured to infer or determine patterns associated with security of the received inputs (e.g., patterns associated with weaknesses, flaws, threats, or potential threats of the received inputs). Such head may also be referred to herein as the “security pattern recognition head.” In some aspects, the security pattern recognition head may help to identify and prioritize patterns relevant to context of the code received by the LLM(S) 123, thereby reducing noise or irrelevant information that otherwise may have been processed by the LLM(S) 123. In some embodiments, the security pattern recognition head may be pre-trained using data or information representing secure coding practices, security vulnerabilities, CVEs, or data associated with OWASP. Further, the security pattern recognition head may be fine-tuned using, for example, threat models and CVEs. The multi-head attention may also include a risk analysis head that includes attention layers used to prioritize security vulnerabilities associated with the received inputs. In some aspects, the attention layers may prioritize the security vulnerabilities based on an impact analysis of the received input and the likelihood of one or more threats associated with the received input being realized. In some embodiments, one or more of patterns, security vulnerabilities (or threats), or the prioritization of security vulnerabilities may be output (e.g., as vectors) to a vector database (e.g., of the database(s) 126) at 385. In some aspects, the multi-head attention may also be configured to receive vectors from the vector database at 385. Further, in some embodiments, the multi-head attention may be configured to output one or more of patterns, security vulnerabilities (or threats), or the prioritization of the security vulnerabilities (or vectors received from the vector database at 385) to the feedforward network at 330.

At 330, the feedforward network may receive position encodings from 320, or one or more of patterns, security vulnerabilities (or threats), or the prioritization of security vulnerabilities or other information (e.g., as vectors) from the multi-head attention at 325. In some embodiments, the feedforward network may use transformations to process this received information or data, in order to refine the identified security vulnerabilities or the prioritization of the identified security vulnerabilities.

At 335, the LLM(S) 123 may use layer normalization to normalize, for example, refined security vulnerabilities and refined prioritization output from the feedforward network. In some aspects, the layer normalization may stabilize the flow of data being processed by the LLM(S) 123 (e.g., during training, learning, or deployment), and help to ensure accuracy and consistency of the detection of security vulnerabilities (or the security analysis) performed by the LLM(S) 123.

At 340, decode layers of the LLM(S) 123 may process or decode data or information normalized at 335, to output, as sequences, one or more of a threat model or suggested remediations. At 345, the LLM(S) 123 may perform output projection by mapping the sequences output from the decode layers to classes (or types or categories) of security vulnerabilities or threats.

At 350, a softmax layer of the LLM(S) 123 may assign probabilities to (or determine probability distributions for) the classified threats from 345. In some aspects, the assigned probabilities may represent rankings of the classified threats based on, for example, (i) the severity of consequences that may result if the categorized threats are realized, and (ii) the likelihood that each of the categorized threats may be realized.

At 355, the LLM(S) 123 may convert outputs from the softmax layer (e.g., classified threats and rankings associated with the classified threats) into final output tokens. The final output tokens may be represented as, for example, a threat model that identifies the classified threats and rankings of the classified threats. In some embodiments, the final output tokens may include recommended remediations for the classified threats, where the recommended remediations may optionally be included in the threat model.

At 360, the final output tokens or threat model may be visualized using a user interface dashboard presented on a display screen associated with the second computing system 120.

Where recommended remediations were not generated or output at 355, the LLM(S) 123 may use a mitigation generator at 365 to generate one or more recommended remediations for classified threats presented in the threat model. At 370, the LLM(S) 123 may use a code/infrastructure remediation engine to generate code (e.g., software patches or fixes in Python, Java, Javascript or other programming languages) that remediates one or more of the classified threats of the threat model. In some embodiments, the code/infrastructure remediation engine may (e.g., automatically) generate code that reflects the one or more recommended remediations generated at 365. In some embodiments, the code (e.g., secure code) generated by the code/infrastructure remediation engine may be deployed at 375. For example, the LLM(S) 123 may cause the code generated by the code/infrastructure remediation engine to be directly applied to code or infrastructure templates (e.g., stored on the second computing system 120). As another example, the LLM(S) 123 may cause the code generated by the code/infrastructure remediation engine to be transmitted to the first computing system 110 (e.g., for integration into a codebase and testing). As another example, the LLM(S) 123 may cause the code generated by the code/infrastructure remediation engine to be transmitted to the third computing system 140 for production, or for incorporation into a codebase for production. In some embodiments, the mitigation generator may be fine-tuned using data from open source security patch repositories or secure coding standards. Further, the mitigation generator may be configured to implement few-shot learning to adapt code fixes for new threats dynamically (e.g., on the fly).

In some embodiments, at 380, the second computing system 120 may use a telemetry service to monitor, log, or track performance of the LLM(S) 123 (optionally based on the visualized data of 360). In some aspects, the telemetry service may provide or generate data in real time that may be used to improve the threat detection and remediation of the LLM(S) 123. In some embodiments, the telemetry service may output such data to a continuous learning module at 390 or to the vector database at 385.

At 390, the continuous learning module (or layer) may receive output from the decoding layers at 340 (e.g., sequences representing one or more of a threat model or suggested remediations), and data from the telemetry service at 380. In some embodiments, the continuous learning module (or layer) may also receive, in real time, an intelligence feed that represents current threats. In some aspects, the continuous learning model may help ensure that the LLM(S) 123 receive, as input, or are trained using, active or emerging (or current) threats or suggested remediations. The continuous learning module may include a feedback mechanism by which a software developer may supply feedback (e.g., regarding suggested remediations) to the continuous learning module. In some embodiments, the continuous learning module (or layer) may also include a reinforcement learning layer configured to adjust weights of the LLM(S) 123 based on received feedback or received active or emerging (or current) threats or suggested remediations. In some embodiments, the continuous learning module may output such received input to the vector database at 385.

At 385, the vector database may store inputs received from the continuous learning module at 290, the telemetry service at 380, or the multi-head attention at 325, as vectors, for example. The vector database may further store historical data (e.g., historical threats or historical code) or common remediations. The vector database may also be configured to output such data to the multi-head attention at 325 or a future threat and mitigation (“TM”) module at 395.

At 395, the future threat and mitigation module may be configured to receive inputs (e.g., learned patterns, historical data, active or emerging (or current) threats, or suggested remediations) from the vector database at 385. The future threat and mitigation module may also be configured to store or transmit such received inputs to the decode layers at 340 for enhanced or more accurate future threat detection and remediation.

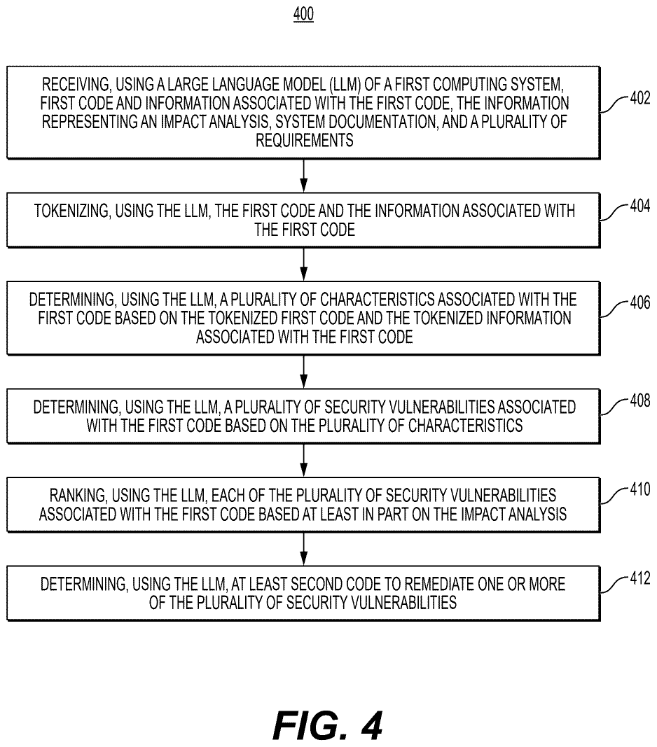

FIG. 4 is a flowchart illustrating a method 400 for detecting and remediating threats associated with source code, in accordance with one or more embodiments. In some aspects, the method 400 may be performed by the second computing system 120 (e.g., the LLM(S) 123).

As shown in FIG. 4, the method 400 may include receiving, using a large language model (“LLM”) of a first computing system (e.g., the second computing system 120), first code (e.g., the code 130) and information associated with the first code, the information representing an impact analysis, system documentation, and a plurality of requirements (402). In some embodiments, the first code may be associated with an entity, and the impact analysis (e.g., the impact analysis 131) may represent one or more potential impacts to the entity based on one or more potential failures associated with the first code. Further, the plurality of requirements (e.g., the requirements 132) may represent a plurality of business requirements. The system documentation (e.g., the system documents 133) may represent an architecture associated with the first code. In some embodiments, the first computing system may receive the first code responsive to a code commit.

The method 400 may include tokenizing, using the LLM, the first code and the information associated with the first code (404). The method 400 may include determining, using the LLM, a plurality of characteristics associated with the first code based on the tokenized first code and the tokenized information associated with the first code (406). The method 400 may include determining, using the LLM, a plurality of security vulnerabilities associated with the first code based on the plurality of characteristics (408). The method 400 may include ranking, using the LLM, each of the plurality of security vulnerabilities associated with the first code based at least in part on the impact analysis (410). In some embodiments, each of the plurality of security vulnerabilities may be ranked based on one or more of (i) a likelihood of a respective one of the plurality of security vulnerabilities being exploited, or (ii) a degree of risk associated with a respective one of the plurality of security vulnerabilities. The method 400 may include determining, using the LLM, at least second code to remediate one or more of the plurality of security vulnerabilities (412). In some embodiments, the LLM may include a multi-head attention that includes (i) a first head trained to identify security patterns associated with the tokenized first code, and (ii) a second head trained to prioritize risks associated with the tokenized first code.

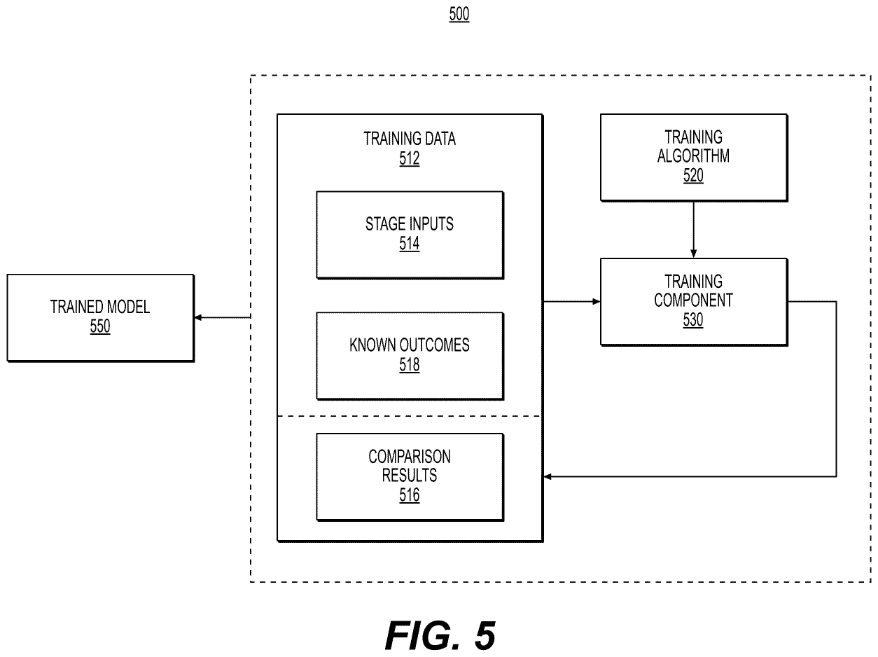

FIG. 5 depicts a flow diagram for training a machine learning model, in accordance with one or more embodiments. As shown in flow diagram 500 of FIG. 5, training data 512 may include one or more of stage inputs 514 and known outcomes 518 related to a machine learning model to be trained. The stage inputs 514 may be from any applicable source including a component or set shown in the figures provided herein. The known outcomes 518 may be included for machine learning models generated based on supervised or semi-supervised training. An unsupervised machine learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine learning model 550. According to an implementation, the training component 530 may be provided comparison results 516 that compare a previous output of the corresponding machine learning model to apply the previous result to re-train the machine learning model. The comparison results 516 may be used by the training component 530 to update the corresponding machine learning model. The training algorithm 520 may utilize machine learning networks or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, or discriminative models such as Decision Forests and maximum margin methods, or the like. The output of the flow diagram 500 may be a trained machine learning model 550.

A machine learning model disclosed herein may be trained by adjusting one or more weights, layers, or biases during a training phase. During the training phase, historical or simulated data may be provided as inputs to the model. The model may adjust one or more of its weights, layers, or biases based on such historical or simulated information. The adjusted weights, layers, or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

In general, any process or operation discussed in this disclosure that is understood to be computer-implementable, such as the processes or operations illustrated in FIGS. 2-5, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

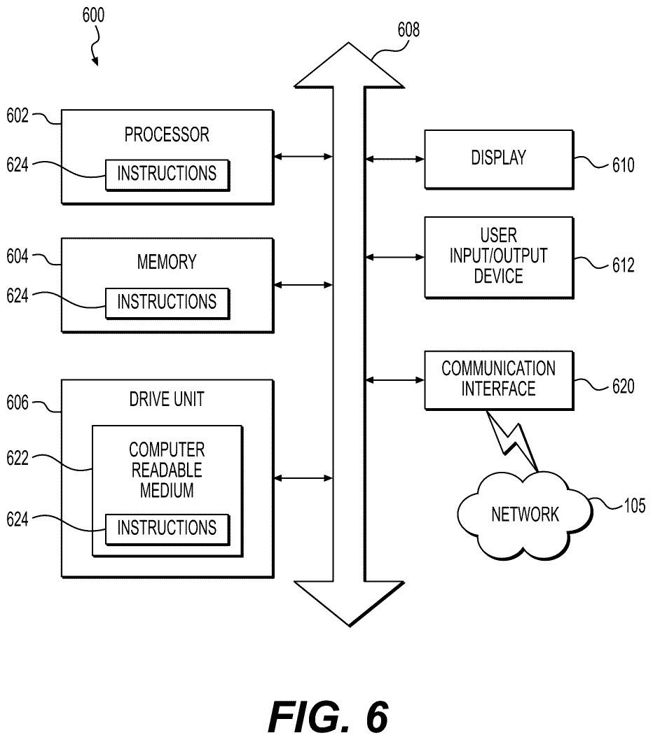

FIG. 6 is a simplified functional block diagram of a computer 600 that may be configured as a device for executing any of the processes, operations, or methods of FIGS. 2-5, according to exemplary embodiments of the present disclosure. For example, the computer 600 may be configured as the first computing system 110, the second computing system 120, or the third computing system 140, according to exemplary embodiments of this disclosure. In various embodiments, any of the devices or systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 or computer readable medium 622). The computer 600 also may include input and output ports 612 or a display (or display screen) 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a large language model (LLM) of a first computing system, first code and information associated with the first code, the information representing an impact analysis, system documentation, and a plurality of requirements;
tokenizing, using the LLM, the first code and the information associated with the first code;
determining, using the LLM, a plurality of characteristics associated with the first code based on the tokenized first code and the tokenized information associated with the first code;
determining, using the LLM, a plurality of security vulnerabilities associated with the first code based on the plurality of characteristics;
ranking, using the LLM, each of the plurality of security vulnerabilities associated with the first code based at least in part on the impact analysis; and
determining, using the LLM, at least second code to remediate one or more of the plurality of security vulnerabilities.

2. The method of claim 1, wherein the first code is associated with an entity, and wherein the impact analysis represents one or more potential impacts to the entity based on one or more potential failures associated with the first code.

3. The method of claim 1, wherein the plurality of requirements represents a plurality of business requirements.

4. The method of claim 1, wherein the system documentation represents an architecture associated with the first code.

5. The method of claim 1, wherein each of the plurality of security vulnerabilities is ranked based on one or more of:
a likelihood of a respective one of the plurality of security vulnerabilities being exploited; or
a degree of risk associated with a respective one of the plurality of security vulnerabilities.

6. The method of claim 1, wherein the first code is received responsive to a code commit.

7. The method of claim 1, wherein the LLM includes a multi-head attention comprising:
a first head trained to identify security patterns associated with the tokenized first code; and
a second head trained to prioritize risks associated with the tokenized first code.

8. The method of claim 1, further comprising:
dynamically receiving, using the LLM, information representing one or more current security threats, and wherein determining, using the LLM, the plurality of security vulnerabilities is further based on the information representing the one or more current security threats.

9. The method of claim 1, wherein determining, using the LLM, the plurality of security vulnerabilities is further based on information representing one or more historical security threats.

10. The method of claim 1, wherein the LLM is trained to analyze code of a plurality of programming languages.

11. The method of claim 1, wherein the plurality of security vulnerabilities is determined using a threat modeling framework.

12. A computing system, comprising:
a processor; and
a memory having programming instructions stored thereon, which, when executed by the processor, cause the computing system to perform operations comprising:
receiving, using a generative machine learning model of a first computing system, first code and information associated with the first code, the information representing an impact analysis, system documentation, and a plurality of requirements;
tokenizing, using the generative machine learning model, the first code and the information associated with the first code;
determining, using the generative machine learning model, a plurality of characteristics associated with the first code based on the tokenized first code and the tokenized information associated with the first code;
determining, using the generative machine learning model, a plurality of security vulnerabilities associated with the first code based on the plurality of characteristics;
ranking, using the generative machine learning model, each of the plurality of security vulnerabilities associated with the first code based at least in part on the impact analysis; and
determining, using the generative machine learning model, at least second code to remediate one or more of the plurality of security vulnerabilities.

13. The computing system of claim 12, wherein the first code is associated with an entity, and wherein the impact analysis represents one or more potential impacts to the entity based on one or more potential failures associated with the first code.

14. The computing system of claim 12, wherein the plurality of requirements represents a plurality of business requirements.

15. The computing system of claim 12, wherein the system documentation represents an architecture associated with the first code.

16. The computing system of claim 12, wherein each of the plurality of security vulnerabilities is ranked based on one or more of:
a likelihood of a respective one of the plurality of security vulnerabilities being exploited; or
a degree of risk associated with a respective one of the plurality of security vulnerabilities.

17. The computing system of claim 12, wherein the first code is received responsive to a code commit.

18. The computing system of claim 12, wherein the generative machine learning model includes a multi-head attention comprising:
a first head trained to identify security patterns associated with the tokenized first code; and
a second head trained to prioritize risks associated with the tokenized first code.

19. The computing system of claim 12, further comprising:
dynamically receiving, using the generative machine learning model, information representing one or more current security threats, and wherein determining, using the generative machine learning model, the plurality of security vulnerabilities is further based on the information representing the one or more current security threats.

20. A method comprising:
receiving, using a large language model (LLM), first code and information associated with the first code, the information representing an impact analysis, system documentation, and a plurality of requirements;
tokenizing, using the LLM, the first code and the information associated with the first code;
determining, using the LLM, a plurality of characteristics associated with the first code based on the tokenized first code and the tokenized information associated with the first code;
determining, using the LLM, a plurality of security vulnerabilities associated with the first code based on the plurality of characteristics;
ranking, using the LLM, each of the plurality of security vulnerabilities associated with the first code based on the impact analysis and a likelihood of a respective one of the plurality of security vulnerabilities being exploited; and
determining, using the LLM, at least second code to remediate one or more of the plurality of security vulnerabilities.
